(19) United States
(12) Patent Application Publication
(10) Pub. No.: US 2007/0002860 A1
(43) Pub. Date: Jan. 4, 2007

(54) Method and system for a digital home network trace and debug tool

(76) Inventors: Frederick J. Cooper, Portland, OR (US); Sandip H. Mandera, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/173,638

(22) Filed: Jun. 30, 2005

(51) Int. Cl. H04L 12/56

(52) U.S. Cl. 370/392

(57) ABSTRACT

A method and system for a digital home network trace and debug tool is described. The system includes a network filter driver to capture packets from a network, a network sniffer manager to manage the network filter driver, a state engine to manage states of the received packets, a packet parser to determine a transport protocol type and a format type for a received packet, one or more packet type parsers to parse the received packets according to the determined format type, and a GUI to display information associated with the received packets. The method includes receiving a packet at a network device, determining whether a source IP address matches a device IP address in a GUI, determining whether a destination IP address matches a device IP address in the GUI, and determining a transport protocol type, and parsing the packet according to the determined transport protocol type. Network packets may be linked or split up as necessary to make logical protocol specific commands. The protocols may also be validated against digital home industry standards.

### TECHNICAL FIELD

Embodiments of the invention relate to digital media software enabling, and more specifically to a digital home network trace and debug tool.

### BACKGROUND

Developing a media product for the digital home often means your product interacts with other products using universal plug and play (UPnP) and streams media through a shared home network. When things do not work as expected, a developer may use a generic network sniffer tool to try to debug the problem. However, the current network sniffer tools show all network packets and show raw data. This means that the current tools not only display packets that the developer is not interested in, but also display the packets in a raw format that is difficult for humans to read. Therefore, it is difficult for the UPnP developer to see the pertinent UPnP and streamed media packets and to debug the problem.

### BRIEF DESCRIPTION OF THE DRAWINGS

The invention is illustrated by way of example, and not by way of limitation, in the figures of the accompanying drawings in which like reference numerals refer to similar elements.

FIG. 1 is a block diagram illustrating a system according to one embodiment of the invention.

FIG. 2 is a flow diagram illustrating a method according to an embodiment of the invention.

FIG. 3 is a flow diagram illustrating a method of processing a TCP packet according to an embodiment of the invention.

FIG. 4 is a flow diagram illustrating a method of parsing packets based on packet format type according to an embodiment of the invention.

FIG. 5 is a flow diagram illustrating a method of parsing a media stream according to an embodiment of the invention.

FIG. 6 is a flow diagram illustrating a method according to an embodiment of the invention.

FIG. 7 is a flow diagram illustrating a method of processing a UDP packet according to an embodiment of the invention.

FIG. 8 is a flow diagram illustrating a method of parsing a SSDP packet according to an embodiment of the invention.

FIG. 9 is a flow diagram illustrating a method of parsing a RTP packet according to an embodiment of the invention.

FIG. 10 is a flow diagram illustrating a method of parsing a RTCP command according to an embodiment of the invention.

FIG. 11 is a flow diagram illustrating a method of parsing a RTSP packet according to an embodiment of the invention.

FIG. 12 is a block diagram illustrating a suitable computing environment in which certain aspects of the illustrated invention may be practiced.

### DETAILED DESCRIPTION

Embodiments of a system and method for a digital home network trace and debug tool are described. In the following description, numerous specific details are set forth. However, it is understood that embodiments of the invention may be practiced without these specific details. In other instances, well-known circuits, structures and techniques have not been shown in detail in order not to obscure the understanding of this description.

Reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

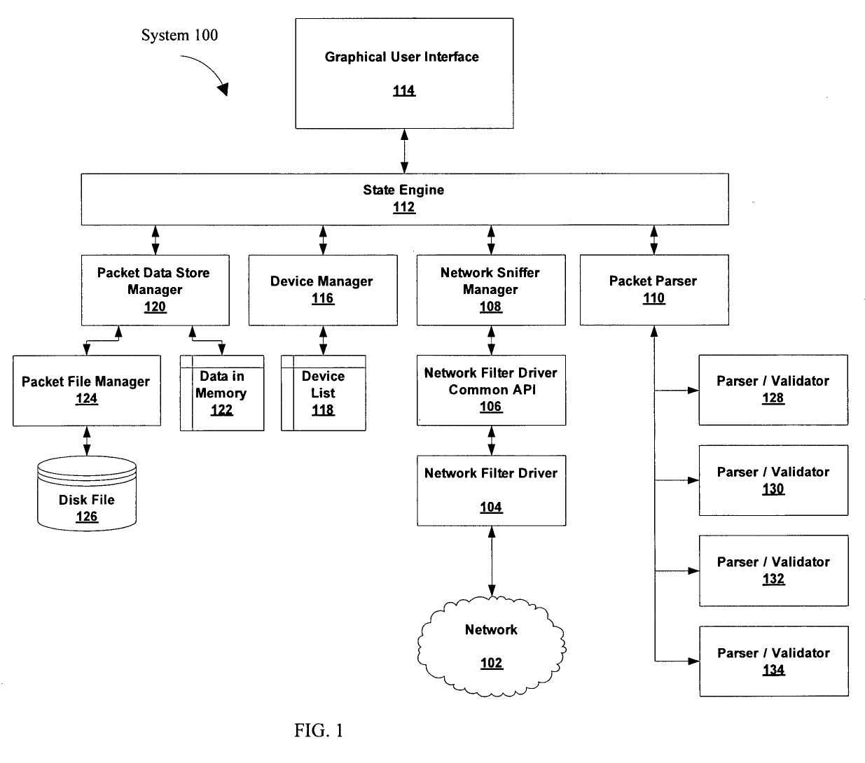

Referring to FIG. 1, a block diagram illustrates a system 100 according to one embodiment of the invention. Those of ordinary skill in the art will appreciate that the system 100 may include more components than those shown in FIG. 1. However, it is not necessary that all of these generally conventional components be shown in order to disclose an illustrative embodiment for practicing the invention.

System 100 includes a network filter driver 104, a network filter driver common application program interface (API) 106, and a network sniffer manager 108 to capture packets from network 102. In one embodiment, the network filter driver 104 is inserted into the network driver stack above the device driver and below the protocol stacks. The network filter driver 104 may run in ring 0 and capture packets. If a received packet is to or from one of the specified Internet Protocol (IP) addresses, the driver copies the packet to a fixed memory buffer and notifies the network sniffer manager 108. The network sniffer manager 108 controls the network filter driver 104, such as setting the network filter driver's parameters and starting and stopping the network filter driver. The network sniffer manager 108 also handles new packet notifications. In one embodiment, the network sniffer manager runs in ring 3. The network sniffer manager 108 copies packet data and adds the packet to a new packet queue to be processed by a packet parser 110. Packet parser 110 processes new packets from the new packet queue, determines which of the supported packet types each packet is, and calls the appropriate packet type parser, such as 128, 130, 132, or 134, to parse the packet.

The system 100 includes one or more packet type parsers, such as 128-134. Each packet type parser parses packets according to a specific supported packet format type. These packet format types may include, but are not limited to General Events Notification Architecture Protocol (GENA), Hypertext Transfer Protocol (HTTP), Simple Object Access Protocol (SOAP), Joint Photographic Experts Group (JPEG) media, Motions Pictures Experts Group, Audio Layer 2, 3, or 4 (MP3, MPEG2, MPEG4) media, Linear Pulse Code Modulation (LPCM) media, Simple Service Discovery Protocol (SSDP), Real-time Transport Protocol (RTP), Real-time Control Protocol (RTCP), or Real-time Streaming Protocol (RTSP).

System 100 includes a packet data store manager 120 to manage the stored data of the received packets. The packet data may be stored in memory 122 or on a disk 126. A packet file manager 124 manages the storing of data on disk 126. In one embodiment, the first line of a packet or a packet summary may be stored in memory 122 and the rest of a packet's data stored on disk 126. System 100 includes a device manager 116. The device manager 116 manages the devices on the system 100 and maintains a device list 118. The device manager 116 may store and identify devices in system 100 by name and not just by IP address. System 100 includes a state engine 112. The state engine 112 keeps track of the states of packets on a global scale, identifies whether a current packet may be connected to a previous packet, keeps track of what devices are available on the network 102 through device manager 116, and keeps track of where data for packets are stored through packet data store manager 120.

The system 100 includes a graphical user interface (GUI) 114. The GUI 114 displays packet information and may show devices available on the system 100. In one embodiment, the GUI 114 only displays information for packets traveling between a few selected universal plug and play (UPnP) devices. All other packet information that is not relevant to a user debugging a particular problem may be filtered out. In one embodiment, the GUI uses arrow packets to show one or more messages traveling from one device to another device. Users may choose devices by name and watch packets travel from one chosen device to another device. The GUI may show summary info based on the type of packet. The GUI organizes and pares down the information gathered by other components of system 100 and displays the information relevant to the user in a format that is more user readable.

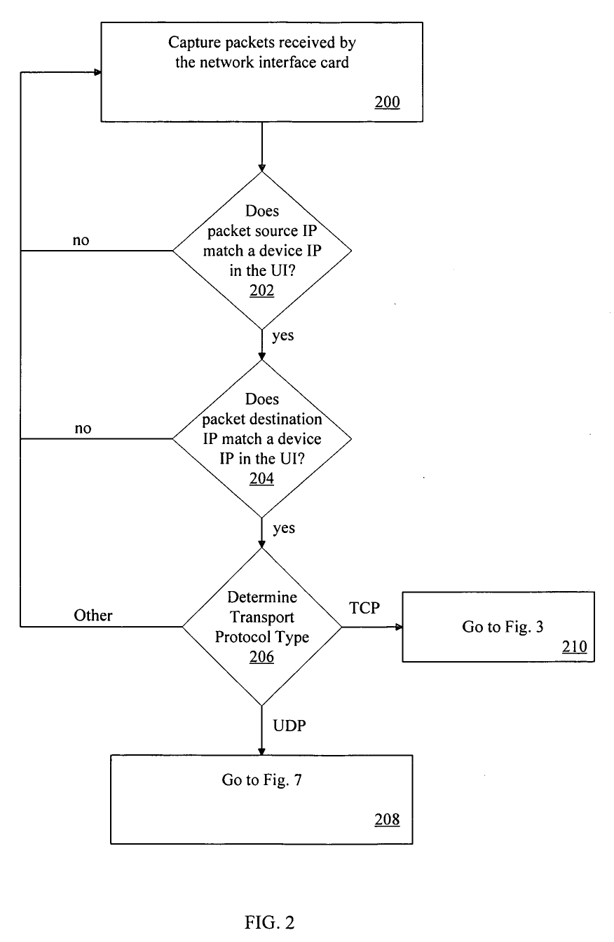

FIG. 2 illustrates a method according to one embodiment of the invention. At 200, packets received by the network interface card are captured. At 202, a determination is made as to whether the source IP address of a received packet matches a device IP address in the user interface. If not, the process proceeds back to 200. If so, at 204, a determination is made as to whether the destination IP address of a received packet matches a device IP address in the user interface. If not, the process proceeds back to 200. If so, at 206, the transport protocol type of the packet is determined. If the transport protocol type is one supported by the system, then the packet is further processed and parsed according to the determined transport protocol type. If the transport protocol type is not one that is supported, then the process proceeds back to 200.

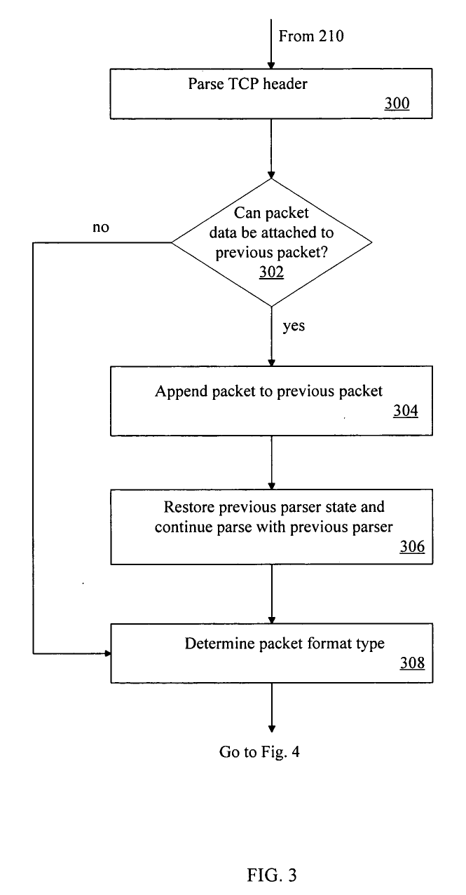

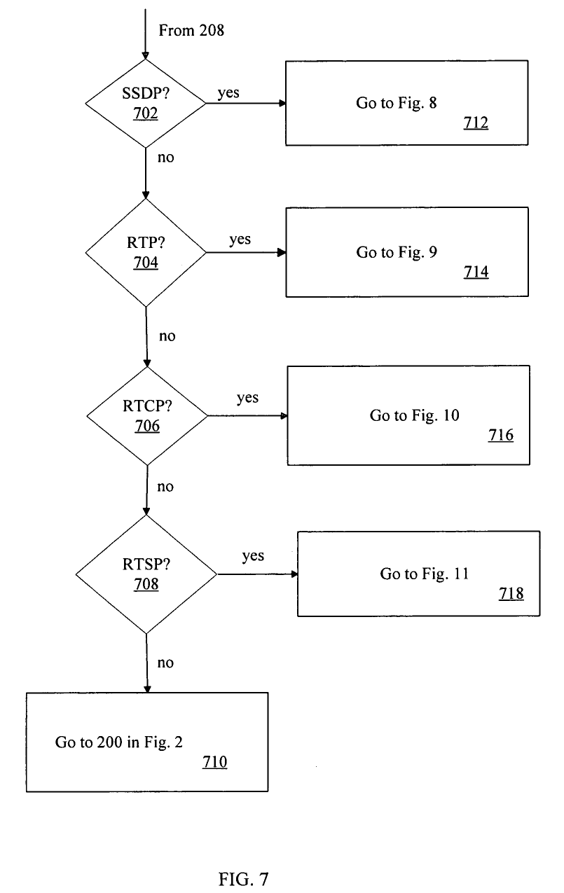

For example, FIG. 2 shows an exemplary embodiment with two supported transport protocol types: Transmission Control Protocol (TCP) and User Datagram Protocol (UDP). If the packet is a TCP packet, then the process proceeds to 210 and the method shown in FIG. 3. If the packet is a UDP packet, then the process proceeds to 208 and the method shown in FIG. 7. Otherwise, for other types of packets, the process proceeds back to 200, where more packets are captured from the network.

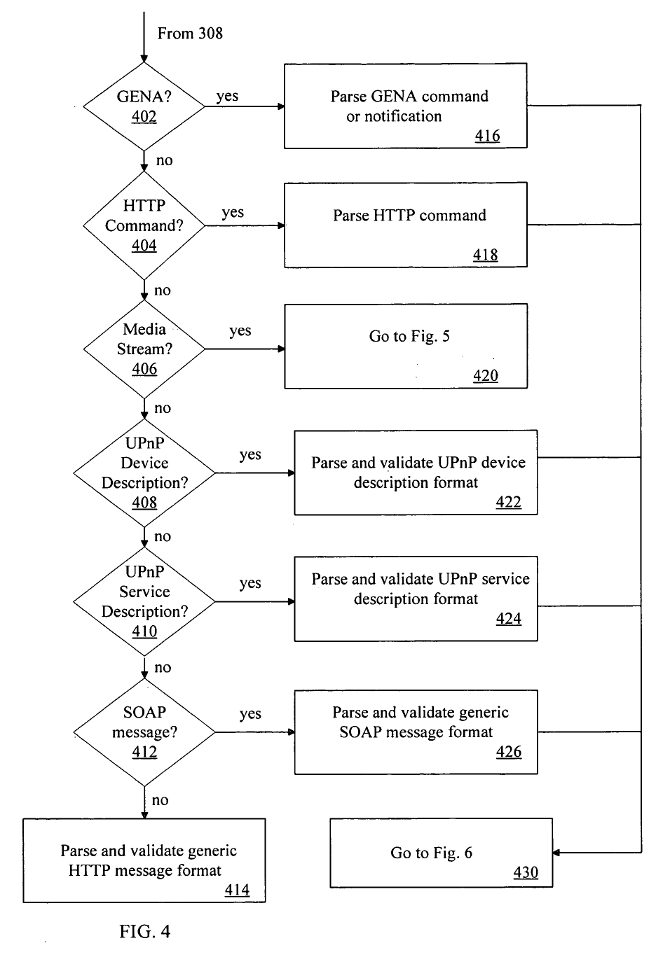

FIG. 3 illustrates a method for processing a TCP packet according to one embodiment of the invention. At 300, the TCP header is parsed. At 302, a determination is made as to whether the packet data may be attached to a previous packet. If not, then the process continues at 308, where the format type of the packet is determined. If so, the process continues at 304, where the packet is appended to the previous packet. Then, at 306, the previous packet parser state is restored and parsing continues with the previous parser. Then, at 308, the packet format type is determined. The process then continues as shown in FIG. 4.

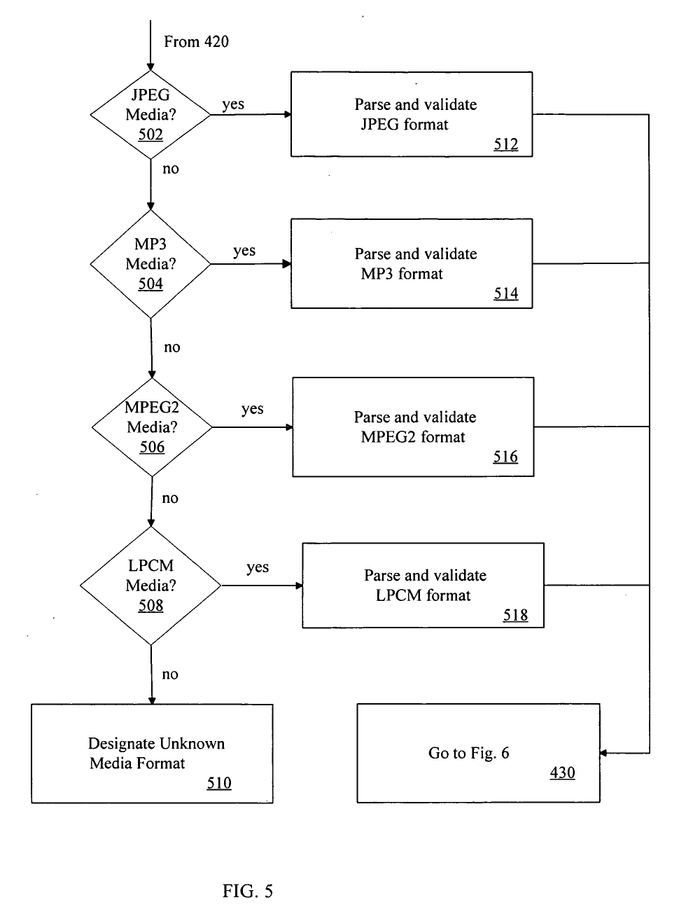

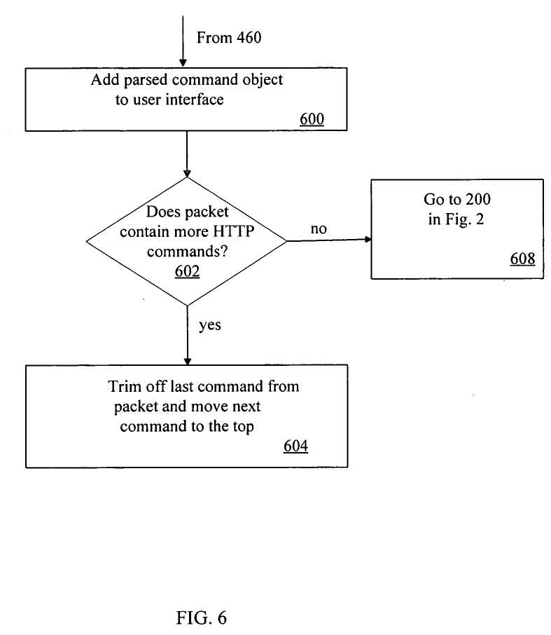

FIG. 4 illustrates a method of parsing packets based on the packet format type according to one embodiment of the invention. At 402-412, the determined packet format type is matched against the predetermined supported packet format types. For example, in the exemplary embodiment shown in FIG. 4, the determined packet format type is matched against six different packet formats: GENA, HTTP command, media stream, UPnP device description, UPnP service description, and SOAP message. If the packet format type matches one of these predetermined packet format types, then the packet is parsed accordingly. For example, if the packet is determined to be a GENA format at 402, then at 416, a determination is made as to whether it is a GENA command or a GENA notification, and the GENA command or notification is then parsed. If the packet is determined to be a HTTP command at 404, then at 418, the HTTP command is parsed. If the packet is determined to be a media stream at 406, then at 420, the process continues as shown in FIG. 5. If the packet is determined to be a UPnP device description at 408, then at 422, the UPnP device description is parsed and validated. If the packet is determined to be a UPnP service description at 410, then at 424, the UPnP service description is parsed and validated. If the packet is determined to be a SOAP message at 412, then at 426, the SOAP description is parsed and validated. After the packet is parsed and validated, the process continues at 430 and proceeds according to FIG. 6. If the packet does not match one of the predetermined packet format types, then at 414, a generic HTTP message format type is used to parse and validate the packet.

FIG. 5 illustrates a method for parsing a media stream according to one embodiment of the invention. At 502-508, the media stream is matched with one or more predetermined media stream formats. For example, in the exemplary embodiment shown in FIG. 5, the media stream is matched against four different predetermined media stream formats: JPEG, MP3, MPEG2, and LPCM. If the media stream matches one of these predetermined media stream formats, then the packet is parsed accordingly. For example, if the packet is determined to be a JPEG media at 502, then at 512, the media stream is parsed and validated according to the JPEG format. If the packet is determined to be a MP3 media at 504, then at 514, the media stream is parsed and validated according to the MP3 format. If the packet is determined to be a MPEG2 media at 506, then at 516, the media stream is parsed and validated according to the MPEG2 format. If the packet is determined to be a LPCM media at 508, then at 518, the media stream is parsed and validated according to the LPCM format. After the media stream is parsed and validated, the process continues to 430 and proceeds according to FIG. 6. If the media stream does not match one of the predetermined media stream formats, then at 510, the media stream is designated as an unknown media format.

FIG. 6 illustrates a method according to one embodiment of the invention. At 600, a parsed command object is added to the user interface. At 602, a determination is made as to whether the packet contains more HTTP commands. If not, then the process continues to 608 and proceeds back to 200 in FIG. 2, where more packets are captured from the network. If so, then the last command from the packet is trimmed off and the next command is moved to the top. The next command may then be processed and parsed in a manner similar to the one described above.

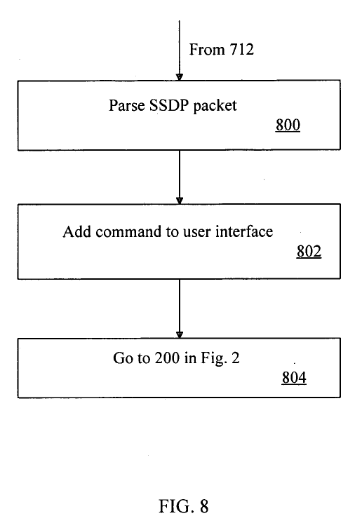

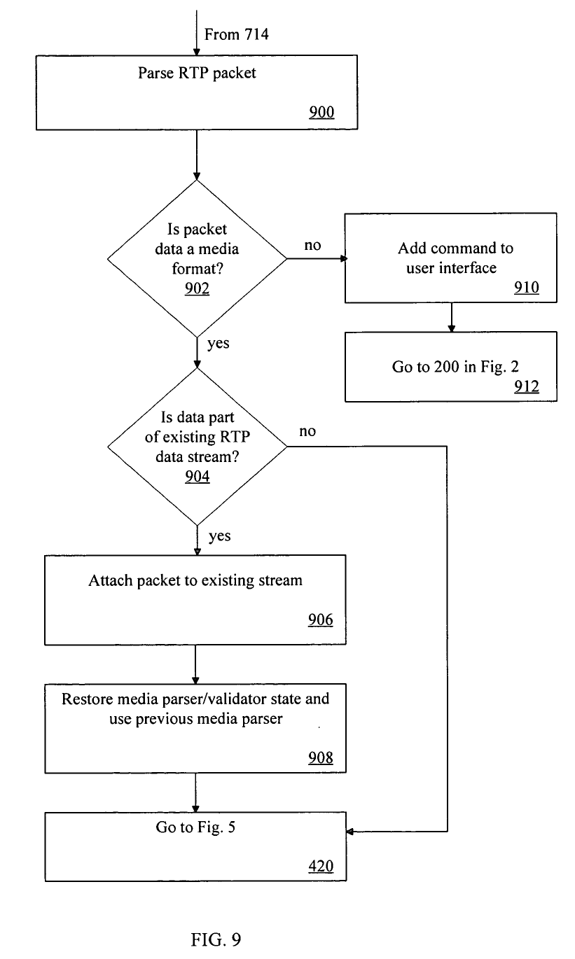

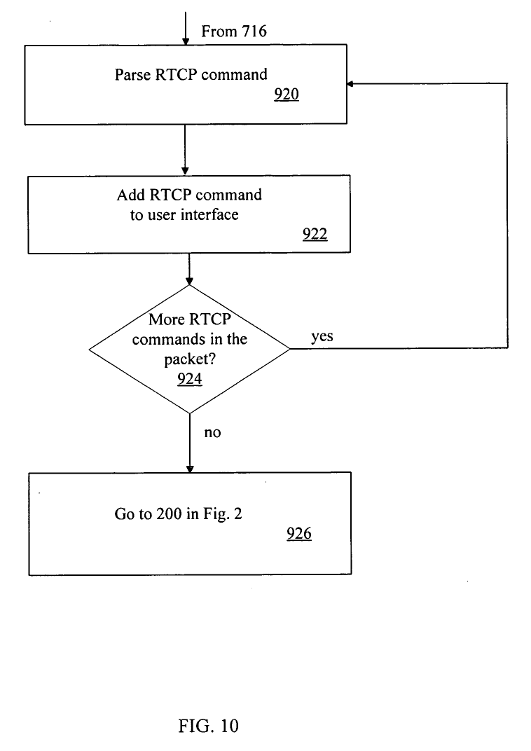

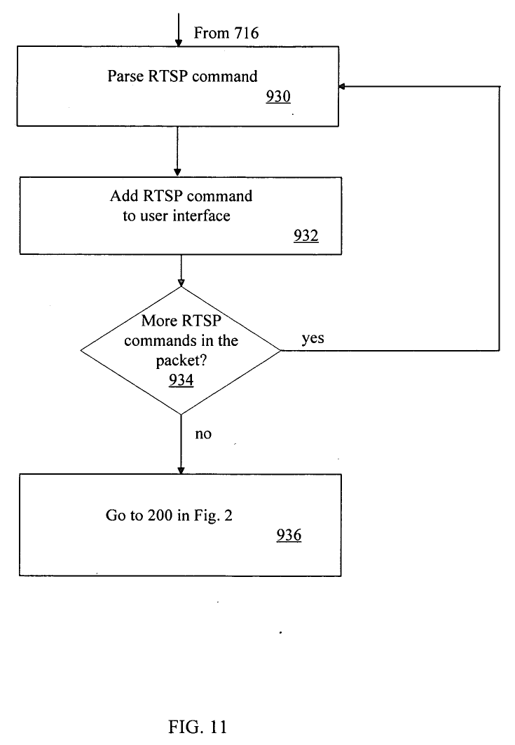

FIG. 7 illustrates a method of processing a UDP packet according to one embodiment of the invention. At 702-708, a determination is made as to whether the packet format type matches one of the predetermined packet format types. For example, in the exemplary embodiment shown in FIG. 7, there are four predetermined packet format types: SSDP, RTP, RTCP, and RTSP. If the packet format type matches one of these predetermined packet format types, then the packet is processed accordingly. For example, if it is determined that the packet is a SSDP packet format at 702, then at 712, the packet is parsed according to the method shown in FIG. 8. If it is determined that the packet is a RTP packet format at 704, then at 714, the packet is parsed according to the method shown in FIG. 9. If it is determined that the packet is a RTCP packet format at 706, then at 716, the packet is parsed according to the method shown in FIG. 10. If it is determined that the packet is a RTSP packet format at 708, then at 718, the packet is parsed according to the method shown in FIG. 11. If the packet format type does not match any of the predetermined packet format types, then at 710, the process proceeds back to 200 in FIG. 2, where more packets are captured from the network.

FIG. 8 illustrates a method of parsing a SSDP packet according to one embodiment of the invention. At 800, the SSDP packet is parsed according to the SSDP format. At 802, the parsed command is added to the user interface. At 804, the process proceeds back to 200 in FIG. 2, where more packets are captured from the network.

FIG. 9 illustrates a method of parsing a RTP packet according to one embodiment of the invention. At 900, the RTP packet is parsed according to the RTP format. At 902, a determination is made as to whether the packet data is a media format. If not, then at 910, the command is added to the user interface, and then at 912, the process proceeds back to 200 in FIG. 2, where more packets are captured from the network. If so, at 904, a determination is made as to whether the data is part of an existing RTP data stream. If not, then at 420, the process proceeds as shown in FIG. 5. If so, then at 906, the packet is attached to the existing steam. At 908, the previous media parser and validator state are restored and the previous media parser is used. Then, at 420, the process proceeds as shown in FIG. 5.

FIG. 10 illustrates a method of parsing a RTCP command according to one embodiment of the invention. At 920, the RTCP command is parsed according to the RTCP command format. At 922, the parsed command is added to the user interface. At 924, a determination is made as to whether the packet contains more RTCP commands. If so, the process continues back to 920, where the additional RTCP commands are parsed. If not, then at 926, the process proceeds back to 200 in FIG. 2, where more packets are captured from the network.

FIG. 11 illustrates a method of parsing a RTSP packet according to one embodiment of the invention. At 930, the RTSP command is parsed according to the RTSP command format. At 932, the parsed command is added to the user interface. At 934, a determination is made as to whether the packet contains more RTSP commands. If so, the process continues back to 930, where the additional RTSP commands are parsed. If not, then at 936, the process proceeds back to 200 in FIG. 2, where more packets are captured from the network.

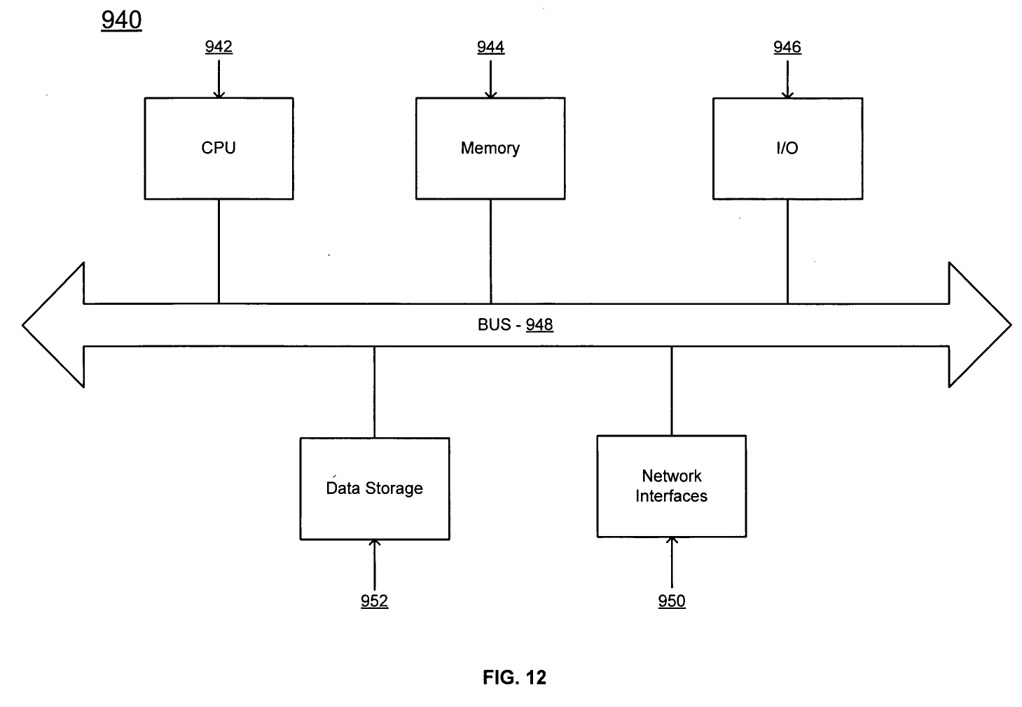

FIG. 12 is a block diagram illustrating a suitable computing environment in which certain aspects of the illustrated invention may be practiced. In one embodiment, the method described above may be implemented on a computer system 940 having components 942-952, including a processor 942, a memory 944, an Input/Output (I/O) device 946, a data storage device 952, and a network interface 950, coupled to each other via a bus 948. The components perform their conventional functions known in the art and provide the means for implementing the system 100. Collectively, these components represent a broad category of hardware systems, including but not limited to general purpose computer systems, mobile or wireless computing systems, and specialized packet forwarding devices. It is to be appreciated that various components of computer system 940 may be rearranged, and that certain implementations of the present invention may not require nor include all of the above components. Furthermore, additional components may be included in system 940, such as additional processors (e.g., a digital signal processor), storage devices, memories (e.g. RAM, ROM, or flash memory), and network or communication interfaces.

As will be appreciated by those skilled in the art, the content for implementing an embodiment of the method of the invention, for example, computer program instructions, may be provided by any machine-readable media which can store data that is accessible by system 100, as part of or in addition to memory, including but not limited to cartridges, magnetic cassettes, flash memory cards, digital video disks, random access memories (RAMs), read-only memories (ROMs), and the like. In this regard, the system 100 is equipped to communicate with such machine-readable media in a manner well-known in the art.

It will be further appreciated by those skilled in the art that the content for implementing an embodiment of the method of the invention may be provided to the system 100 from any external device capable of storing the content and communicating the content to the system 100. For example, in one embodiment of the invention, the system 100 may be connected to a network, and the content may be stored on any device in the network.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
receiving a packet at a network device;
determining whether a source Internet Protocol (IP) address matches a device IP address in a user interface (UI);
determining whether a destination IP address matches a device IP address in the UI;
determining a transport protocol type; and
parsing the packet according to the determined transport protocol type.

2. The method of claim 1, further comprising determining whether the packet may be attached to a previous packet.

3. The method of claim 2, further comprising appending the packet to the previous packet if the packet may be attached to the previous packet.

4. The method of claim 3, further comprising evaluating a group of appended packets for errors.

5. The method of claim 1, further comprising determining a format type of the received packet.

6. The method of claim 5, wherein parsing the packet comprises parsing the packet using a parser associated with the determined packet format type.

7. The method of claim 6, further comprising validating the packet according to the determined packet format type.

8. The method of claim 6, further comprising adding a parsed command of the packet to the user interface.

9. A system comprising:
a network filter driver to capture packets from a network;
a network sniffer manager coupled to the network filter driver to manage the network filter driver;
a state engine coupled to the network sniffer manager to manage states of the received packets and to determine whether a received packet may be attached to a previous packet;
a packet parser coupled to the state engine to determine a transport protocol type and a format type for a received packet; and
a graphical user interface (GUI) coupled to the state engine to display information associated with the received packets.

10. The system of claim 9, further comprising one or more packet type parsers coupled to the packet parser to parse the received packets according to the determined format type.

11. The system of claim 9, further comprising a device manager coupled to the state engine to manage one or more devices in the system.

12. The system of claim 9, further comprising a packet data store manager coupled to the state engine to manage stored data for the received packets.

13. An article of manufacture comprising:
a machine accessible medium including content that when accessed by a machine causes the machine to perform operations including:
receiving a packet at a network device;
determining whether a source Internet Protocol (IP) address matches a device IP address in a user interface (UI);
determining whether a destination IP address matches a device in the UI;
determining a transport protocol type; and
parsing the packet according to the transport protocol type.

14. The article of manufacture of claim 13, wherein the machine-accessible medium further includes content that causes the machine to perform operations comprising determining whether the packet may be attached to a previous packet.

15. The article of manufacture of claim 13, wherein the machine-accessible medium further includes content that causes the machine to perform operations comprising appending the packet to the previous packet if the packet may be attached to the previous packet.

16. The article of manufacture of claim 13, wherein the machine-accessible medium further includes content that causes the machine to perform operations comprising evaluating a group of appended packets for errors as a whole.

17. The article of manufacture of claim 13, wherein the machine-accessible medium further includes content that causes the machine to perform operations comprising determining a packet format type.

18. The article of manufacture of claim 13, wherein parsing the packet comprises parsing the packet using a parser associated with the determined packet format type.

19. The article of manufacture of claim 13, wherein the machine-accessible medium further includes content that causes the machine to perform operations comprising validating the packet according to the determined packet format type.

20. The article of manufacture of claim 13, wherein the machine-accessible medium further includes content that causes the machine to perform operations comprising adding a parsed command of the packet to the user interface.
